(19) United States
(12) Patent Application Publication
(10) Pub. No.: US 2026/0222141 A1
(43) Pub. Date: Jul. 30, 2026

(54) CLI ASSISTED INTER-UE COMMUNICATION

(71) Applicant: QUALCOMM Incorporated, San Diego, CA (US)

(72) Inventors: Zhikun WU, Beijing (CN); Huilin XU, Temecula, CA (US); Ahmed ELSHAFIE, San Diego, CA (US)

(21) Appl. No.: 19/145,188

(22) PCT Filed: Mar. 9, 2023
(86) PCT No.: PCT/CN2023/080436

§ 371 Date: Jul. 1, 2025

(51) Int. Cl. H04L 5/00

(52) U.S. Cl. CPC H04L 5/0048

(57) ABSTRACT

A method for wireless communication at a measurement user equipment (UE) and related apparatus are provided. In the method, the measurement UE receives one or more inter-UE Sounding Reference Signals (SRSs) for communication between the measurement UE and the sounding UE. The measurement UE further performs measurements on the one or more inter-UE SRSs on multiple beams to obtain a communication configuration, transmits the communication configuration to a network entity or the sounding UE, and communicates with the sounding UE based on the communication configuration using at least one measured beam. The method reduces the cross-link interferences and improves the efficiency of wireless communication.

### TECHNICAL FIELD

The present disclosure relates generally to communication systems, and more particularly, to inter user equipment (UE) wireless communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a measurement user equipment (UE). The apparatus may include memory and at least one processor coupled to the memory. Based at least in part on information stored in the memory, the at least one processor may be configured to receive, from a sounding UE, one or more inter-UE Sounding Reference Signals (SRSs) for communication between the measurement UE and the sounding UE; perform measurements on the one or more inter-UE SRSs on multiple beams to obtain a communication configuration; transmit, to a network entity or the sounding UE, the communication configuration; and communicate with the sounding UE based on the communication configuration using at least one measured beam.

In an aspect of the disclosure, a method, a computer-readable medium, and an apparatus are provided for wireless communication at a sounding UE. The apparatus may include memory and at least one processor coupled to the memory. Based at least in part on information stored in the memory, the at least one processor may be configured to transmit, over multiple beams, one or more inter-UE SRSs for inter-UE communication; receive a communication configuration based on the one or more inter-UE SRSs; and communicate, based on the communication configuration, with a second UE or a network entity.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to transmit, to a first UE, a first indication to transmit one or more inter-UE SRSs; receive, from a second UE, a communication configuration for inter-UE communication between the first UE and the second UE based on the one or more inter-UE SRSs; and configure, based on the communication configuration, the first UE for communication with the second UE or the network entity.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example radio frequency identification (RFID) system.

FIG. 5A is a diagram illustrating an example implementation of zero power IoT (ZP IoT) communication.

FIG. 5B is a diagram illustrating another example implementation of ZP IoT communication.

FIG. 6 is a diagram illustrating an example cross-link interference (CLI).

FIG. 7 is a diagram illustrating multiple SRS resources associated with PUCCH/PDCCH.

FIG. 8A is a diagram illustrating a CLI-SRS framework.

FIG. 8B is a diagram illustrating a dedicated SRS framework in accordance with various aspects of the present disclosure.

FIG. 9A is a diagram illustrating a Quasi Co-Location (QCL) framework.

FIG. 9B is a diagram illustrating a dedicated SRS framework in accordance with various aspects of the present disclosure.

FIG. 10A is a diagram illustrating an example of dedicated SRS for inter-UE communication in accordance with various aspects of the present disclosure.

FIG. 10B is a diagram illustrating another example of dedicated SRS for inter-UE communication in accordance with various aspects of the present disclosure.

FIG. 11A is a diagram illustrating an example of dedicated SRS for inter-UE communication in accordance with various aspects of the present disclosure.

FIG. 11B is a diagram illustrating another example of dedicated SRS for inter-UE communication in accordance with various aspects of the present disclosure.

FIG. 12 is a call flow diagram illustrating a method of wireless communication in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a UE in accordance with various aspects of the present disclosure.

FIG. 16 is a flowchart illustrating methods of wireless communication at a UE in accordance with various aspects of the present disclosure.

FIG. 17 is a flowchart illustrating methods of wireless communication at a network entity in accordance with various aspects of the present disclosure.

FIG. 18 is a flowchart illustrating methods of wireless communication at a network entity in accordance with various aspects of the present disclosure.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

Transmissions from one UE may cause interference to reception by another UE. Such interference may be referred to as CLI. In some aspects, UEs may communicate with each other using a Uu interface or a zero-power internet of things (ZP IoT) interface, for example. In some aspects, inter-UE coordination may enable multiple readers to coordinate to obtain tag positioning or inter-UE collision avoidance. In other aspects, inter-UE coordination may enable half-duplex readers to coordinate for tag communication or to maintain tag power. Aspects presented herein provide a CLI framework for inter-UE coordination that enables CLI RS (e.g., CLI SRS) resources to be configured at an interfered UE for RSRP measurement of interference from an interfering UE. The interfered UE, which may be referred to as a measuring UE or a measurement UE, may also use the RS to assist with inter-UE communication.

Various aspects relate generally to wireless communication. Some aspects more specifically relate to CLI-assisted inter-UE wireless communication. In some examples, a measurement UE may receive, from a sounding UE, one or more inter-UE SRSs for communication between the measurement UE and the sounding UE; perform measurements on the one or more inter-UE SRSs on multiple beams to obtain a communication configuration; transmit, to a network entity or the sounding UE, the communication configuration; and communicate with the sounding UE based on the communication configuration using at least one measured beam. In some examples, a sounding UE may transmit, over multiple beams, one or more inter-UE SRSs for inter-UE communication; receive a communication configuration based on the one or more inter-UE SRSs; and communicate, based on the communication configuration, with a second UE or a network entity. In some aspects, the one or more inter-UE SRSs may be sources for QCL in a transmission configuration indication (TCI) state between the measurement UE and the sounding UE.

Particular aspects of the subject matter described in this disclosure can be implemented to realize one or more of the following potential advantages. In some examples, by receiving, from a sounding UE, one or more inter-UE SRSs for communication between the measurement UE and the sounding UE; performing measurements on the one or more inter-UE SRSs on multiple beams to obtain a communication configuration; and transmitting the communication configuration to the network entity or the sounding UE, the described techniques can be used to coordinate multiple UEs to reduce the CLI. Additionally, the described techniques provide dedicated SRSs that may work as the QCL sources for inter-UE communication or DL/UL communication to improve the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

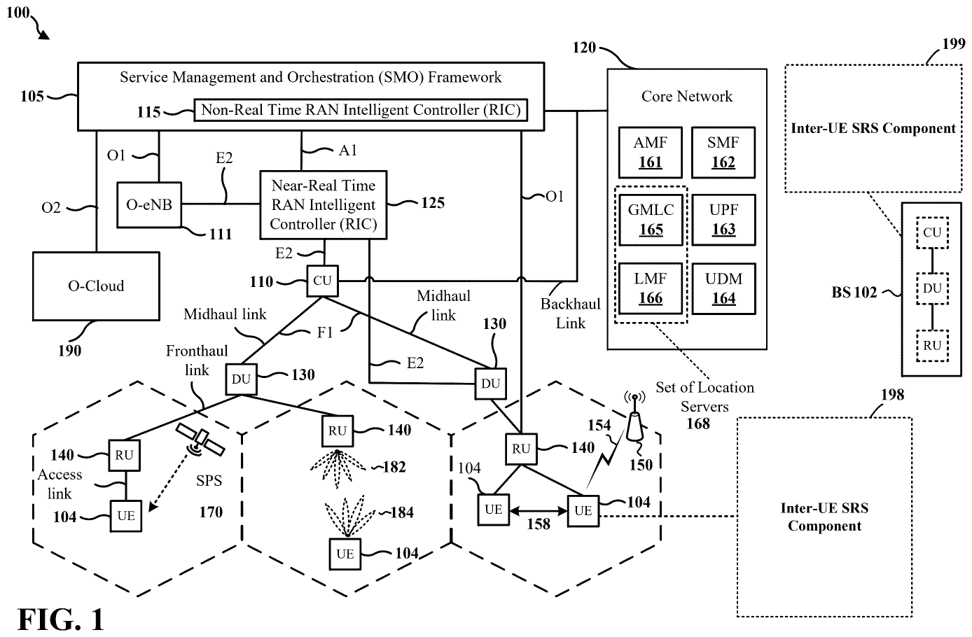

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an inter-UE SRS component 198. In some aspects, the inter-UE SRS component 198 may be configured to receive, from a sounding UE, one or more inter-UE SRSs for communication between the measurement UE and the sounding UE; perform measurements on the one or more inter-UE SRSs on multiple beams to obtain a communication configuration; transmit, to a network entity or the sounding UE, the communication configuration; and communicate with the sounding UE based on the communication configuration using at least one measured beam. In some aspects, the inter-UE SRS component 198 may be configured to transmit, over multiple beams, one or more inter-UE SRSs for inter-UE communication; receive a communication configuration based on the one or more inter-UE SRSs; and communicate, based on the communication configuration, with a second UE or a network entity. In certain aspects, the base station 102 may include an inter-UE SRS component 199. The inter-UE SRS component 199 may be configured to transmit, to a first UE, a first indication to transmit one or more inter-UE SRSs; receive, from a second UE, a communication configuration for inter-UE communication between the first UE and the second UE based on the one or more inter-UE SRSs; and configure, based on the communication configuration, the first UE for communication with the second UE or the network entity. Although the following description may be focused on 5G NR, the concepts described herein may be applicable to other similar areas, such as LTE, LTE-A, CDMA, GSM, and other wireless technologies.

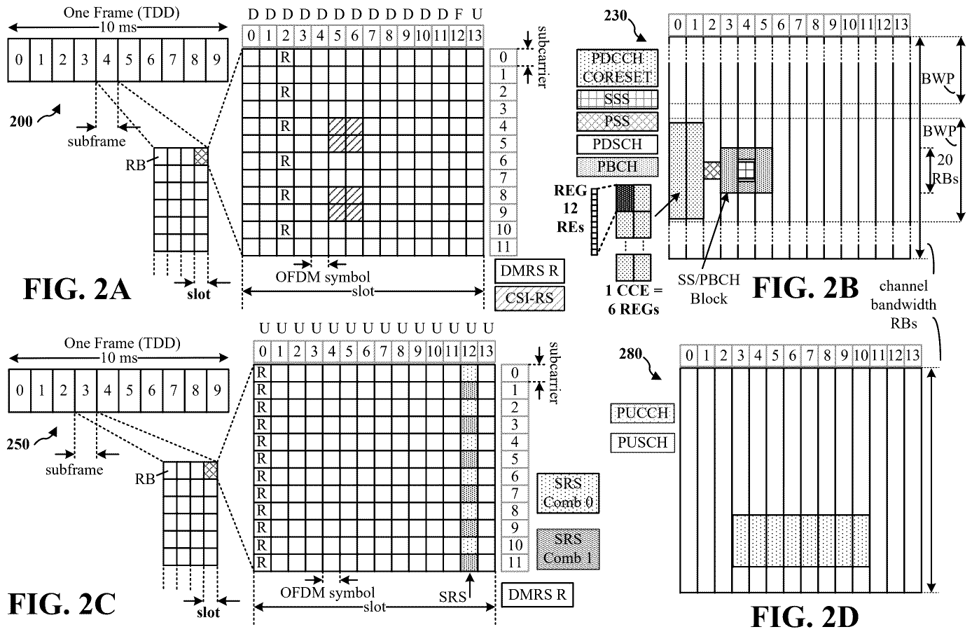

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

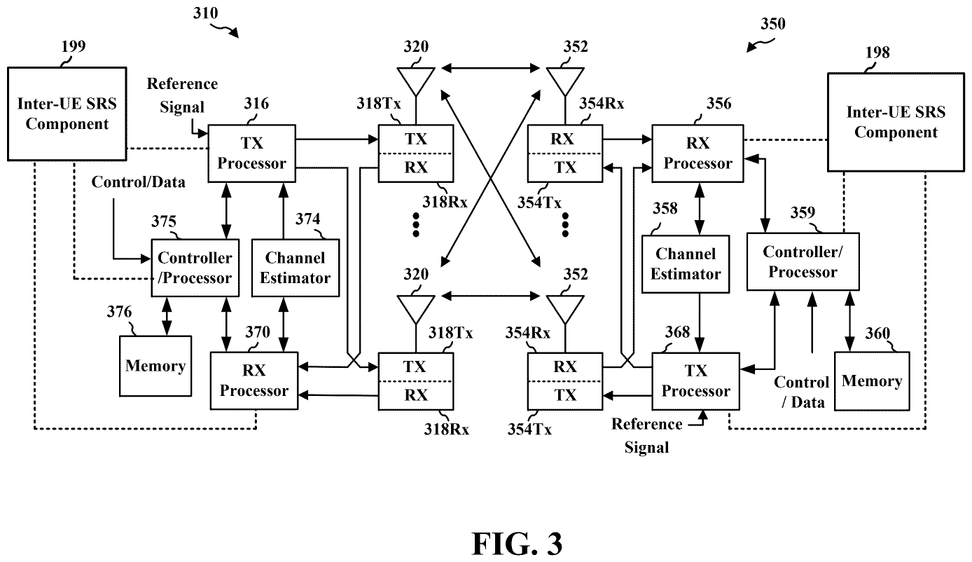

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to an RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the inter-UE SRS component 198 of FIG. 1.

At least one of the TX processor 316, the RX processor 370, and the controller/processor 375 may be configured to perform aspects in connection with the inter-UE SRS component 199 of FIG. 1.

Passive Internet of Things (IoT) devices are devices that rely on passive communication technologies, such as backscatter communication, to reduce the power consumption and cost of devices. Such devices may be referred to as passive devices, backscatter devices, energy harvesting devices, zero power devices, ZP IoT devices, passive IoT devices, etc. Some passive IoT devices may communicate in wireless telecommunication systems, such as an NR system, rather than in a commercial communication system, such as the ultra-high frequency radio frequency identification (UHF RFID) systems, which is based on backscatter communication in the Industrial, Scientific, and Medical (ISM) frequency band. In contrast, backscatter communication in the NR system may work in the licensed band that is different from the ISM band and may include interferences between the RFID systems and wireless telecommunication systems that are not present in the UHF RFID systems. Hence, a new design of passive IoT compatible with the telecommunication system is presented herein.

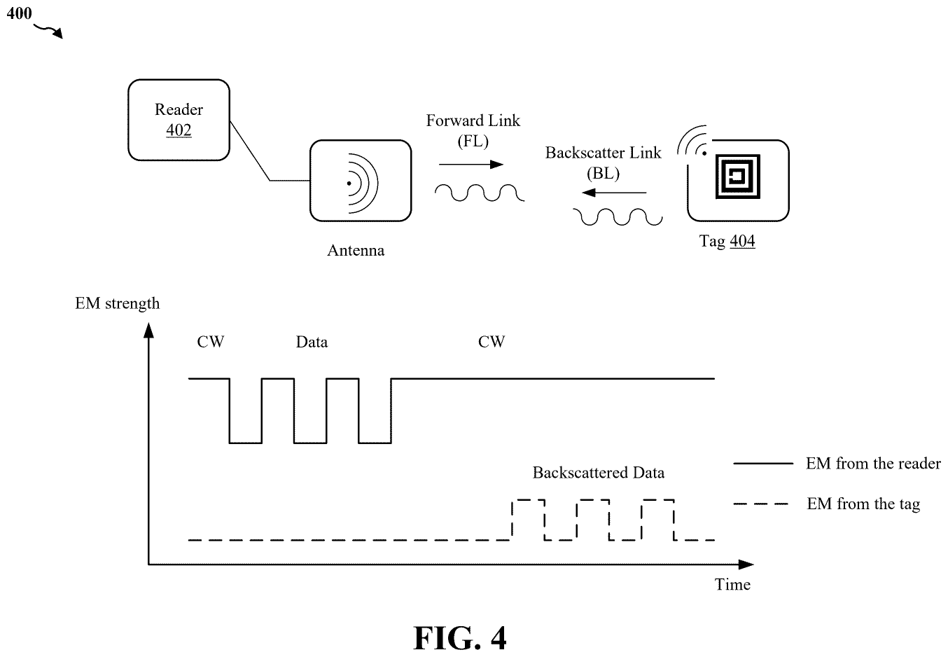

FIG. 4 is a diagram 400 illustrating an example RFID system. As shown in FIG. 4, an RFID system may include a reader 402 and a tag 404. The reader 402 may transmit, through an antenna, an electromagnetic (EM) signal to the tag 404 through a forward link (FL). The tag 404 may detect the EM signal from the reader 402, for example, through a circuit known as the “envelope detector,” and reflect or scatter the EM signal it encounters through a backscatter link (BL) back to the reader 402. The reflected EM signal may be modulated by the tag 404 to include the backscatter data for the reader 402.

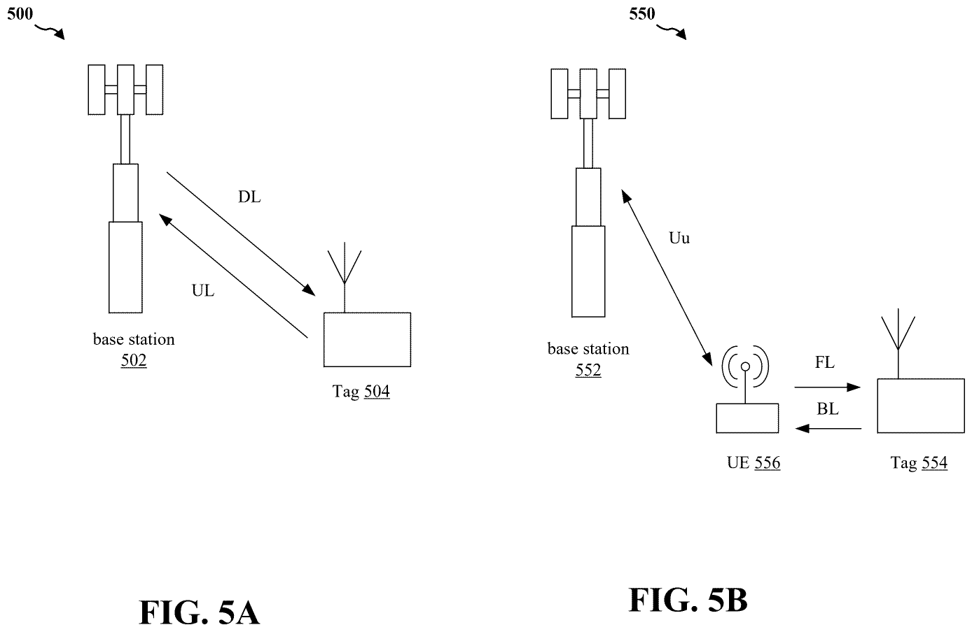

FIG. 5A is a diagram 500 illustrating an example implementation of zero power IoT (ZP IoT) communication. As shown in FIG. 5A, a base station 502 may directly communicate with a tag 504 through DL and UL communication. FIG. 5B is a diagram 550 illustrating another example implementation of ZP IoT communication. As shown in FIG. 5B, a base station 552 may communicate with a tag 554 through a UE 556. The UE 556 may work as a relay between the base station 552 and the tag 554. That is, the base station 552 may communicate with the UE 556 via the Uu interface (a wireless interface that connects the UE 556 to the base station 552), and the UE 556 may communicate with the tag 554 via the FL link and the BL link.

Cross-link interference (CLI) may occur between two or more devices that operate in the same frequency band and may cause a reduction in signal quality. Hence, the CLI measurement may be used when two devices (e.g., a UE and a reader, which may be a specialized UE device) communicate on the same frequency channel simultaneously (e.g., overlapping at least partially in time), with one device transmitting and the other device receiving using the frequency channel.

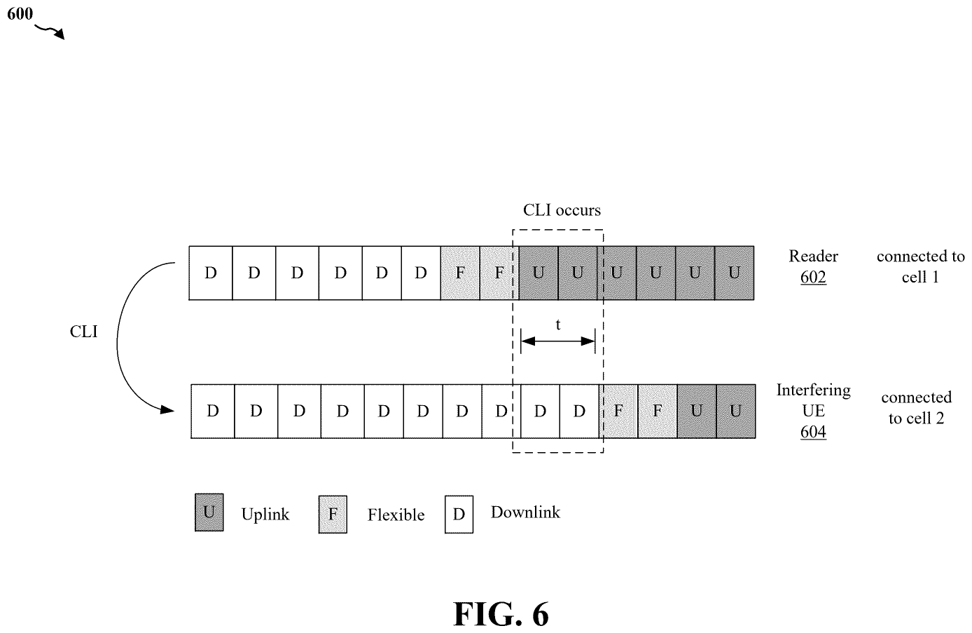

FIG. 6 is a diagram 600 illustrating an example CLI. As shown in FIG. 6, when a reader 602 (which may be connected with cell 1) is transmitting using a band during time t, and a UE (which may be referred to as an interfering UE) 604 connected with cell 2 is receiving using the same band, the CLI may occur. The reader 602 or the UE 604 may be configured with specific resources for CLI measurements and may report the CLI measurement result to the corresponding cell.

The UEs in the ZP IoT communication may support the Uu interface and the ZP IoT interface (an interface used by the ZP IoT devices to send data to, or receive commands from, other devices or networks). Inter-UE (or inter-reader) coordination may improve the ZP IoT communication. For example, multiple readers may be coordinated for the tag positioning and the inter-UE collision avoidance. Multiple readers (e.g., readers with half duplex) may coordinate to realize the tag communication or to keep the tag power up.

However, the UEs (readers) in the ZP IoT communication might not support sidelink communication and the data rate of backscattered signals is small. Hence, the Uu interface or Uu link (e.g., through PUCCH) may be used for relaying raw In-phase and Quadrature-phase (I/Q) among multiple UEs, e.g., for inter-UE communication that is transmitted from one UE directly to another UE.

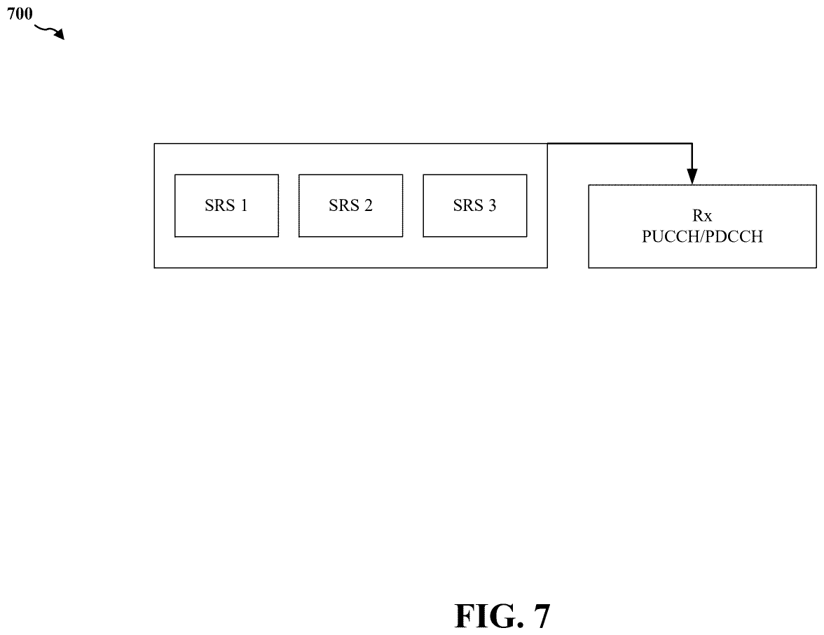

The present disclosure provides methods and apparatus for utilizing CLI for inter-UE communication. When using CLI for inter-UE coordination, a UE (e.g., a receiving reader) may have some CLI Sounding Reference Signal (SRS) resource associated with receiving UCI/DCI resources. For example, FIG. 7 is a diagram 700 illustrating multiple SRS resources associated with PUCCH/PDCCH. As shown in FIG. 7, a UE may have multiple SRS resources (e.g., SRS 1, SRS 2, and SRS 3) associated with receiving PUCCH/PDCCH. For the CLI measurements in some wireless standards (a set of specifications or protocols that define how wireless devices communicate with each other over a wireless network), the CLI SRS resources can be configured at the UE experiencing the CLI (which may be referred to as the interfered UE, a measuring UE, or a victim UE that experiences interference) for RSRP measurement of the inter-UE interference. These CLI SRS resources may correspond to the regular SRS transmitted from an interfering UE (i.e., a transmitting UE that causes the CLI to the interfered UE) to the base station for uplink channel measurement. These CLI SRSs may not be dedicated SRS for the CLI measurement. When the transmitter of the inter-UE communication link is also transmitting an SRS to the base station, this SRS may be used to assist the inter-UE communication. As presented herein, the configuration for CLI SRS can be reused for the receiver to receive the SRS. As used herein, the “interfering UE” may also be referred to as the “transmit (Tx) UE” or the “sounding UE,” and the “interfered UE” may also be referred to as the “receive (Rx) UE” or the “measurement UE.”

Before an Rx UE decodes PUCCH/PDCCH for inter-UE communication, the Rx UE may be informed of information related to the inter-UE communication. The information may include the Automatic Gain Control (AGC) at the receiver, the timing of signals from the Tx UE to the Rx UE, the channel estimation, and the spatial filter (if FR2 is used). Such information may be provided via the associated reference signals transmitted before PUCCH/PDCCH. In order to provide such information, CLI SRS may be adjusted as presented herein to meet these requirements. For example, if FR2 is used, the Tx UE may use different Tx beams for transmitting the CLI SRS and the associated PDCCH/PUCCH, which may result in different Rx power at the Rx UE. As a result, the CLI-SRS may not work as a reference signal for the Rx UE AGC setting or for the Rx timing for the Rx UE. Additionally, the current beam sweeping and beam alignment procedure (e.g., the P1, P2, P3 procedure) may be based on the “repetition” abilities of the CSI-SR, and the current CLI-SRS may not support these features. Hence, existing CLI-SRS may not work for the Rx UE AGC setting and may not be used as the QCL source of inter-UE communication.

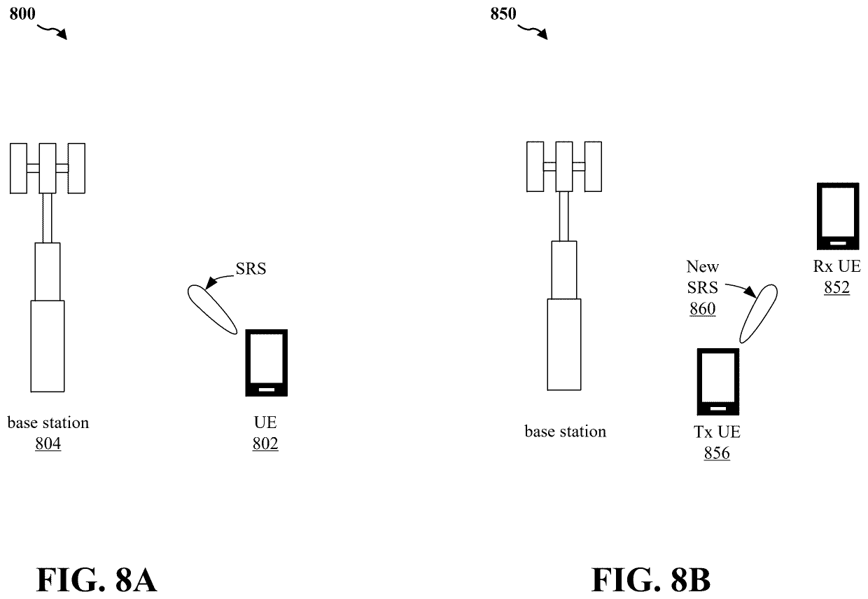

Example aspects presented herein provide a dedicated SRS for inter-UE communication, and enables UEs to receive and use these dedicated SRS to enable inter-UE communication. The dedicated SRS may be a separate SRS, different than CLI-SRS that do not enable inter-UE communication. FIG. 8A is a diagram 800 illustrating a CLI-SRS framework, in which a UE 802 may transmit an SRS (e.g., a CLI-SRS) to the base station 804. FIG. 8B is a diagram 850 illustrating a dedicated SRS framework in accordance with various aspects of the present disclosure. As shown in FIG. 8B, a Tx UE 856 may transmit a dedicated SRS (e.g., the new SRS 860) to an Rx UE 852, and the dedicated SRS may be used for the inter-UE communication.

In some aspects, the dedicated SRS may work as the QCL source for PUCCH/PDCCH or for Tx and Rx between the UEs. The QCL relationship (e.g., the QCL type) may be type A, type B, type C, or type D. The QCL type A may be a first QCL type related to the doppler shift, the doppler spread, the average delay, and the delay spread of the transmission channel. The QCL type B may be a second QCL type related to the doppler shift and the doppler spread of the transmission channel. The QCL type C may be a third QCL type related to the average delay and the doppler shift of the transmission channel, and the QCL type D may be a fourth QCL type related to the spatial receive parameter of the transmission channel.

In some aspects, the dedicated SRS may be indicated in TCI state or SRS resource indicator (SRI) as the QCL source, or other configuration methods. The dedicated SRS (for the Rx measurement) may work standalone without regarding another RS as a QCL source. In some aspects, the dedicated SRS may be periodic and may be activated or deactivated by the base station. In some aspects, the dedicated SRS may be aperiodic (or dynamic). In some aspects, the BWP for the dedicated SRS may be different from the BWP for the Uu link for inter-UE communication.

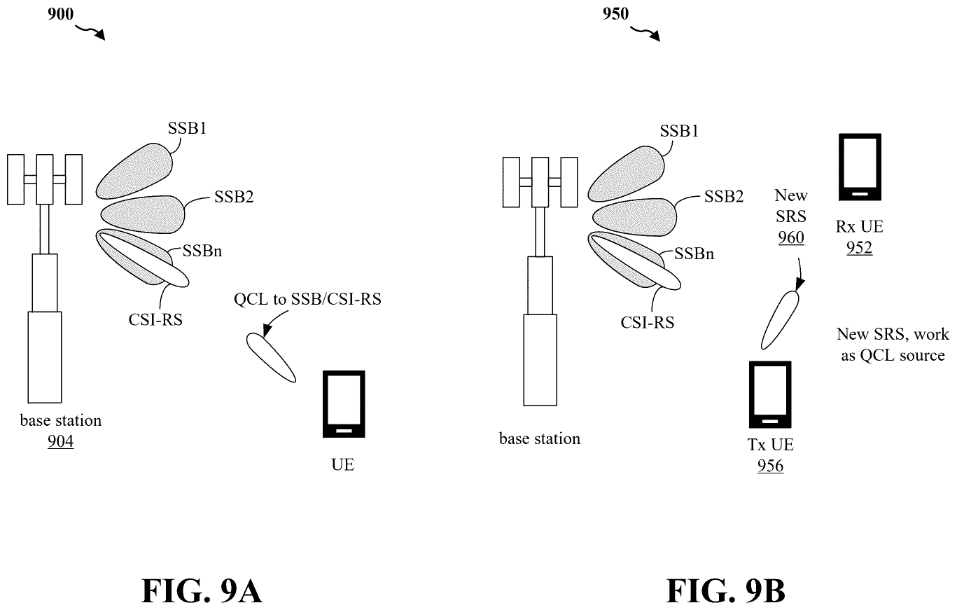

FIG. 9A is a diagram 900 illustrating a QCL framework, in which the QCL may be associated with the SSB (e.g., SSB1, SSB2, . . . , SSBn) or the CSI-RS of the base station 904. FIG. 9B is a diagram 950 illustrating a dedicated SRS framework in accordance with various aspects of the present disclosure. As shown in FIG. 9B, a Tx UE 956 may transmit a dedicated SRS (e.g., the new SRS 960) to an Rx UE 952, and the dedicated SRS may work as the QCL source.

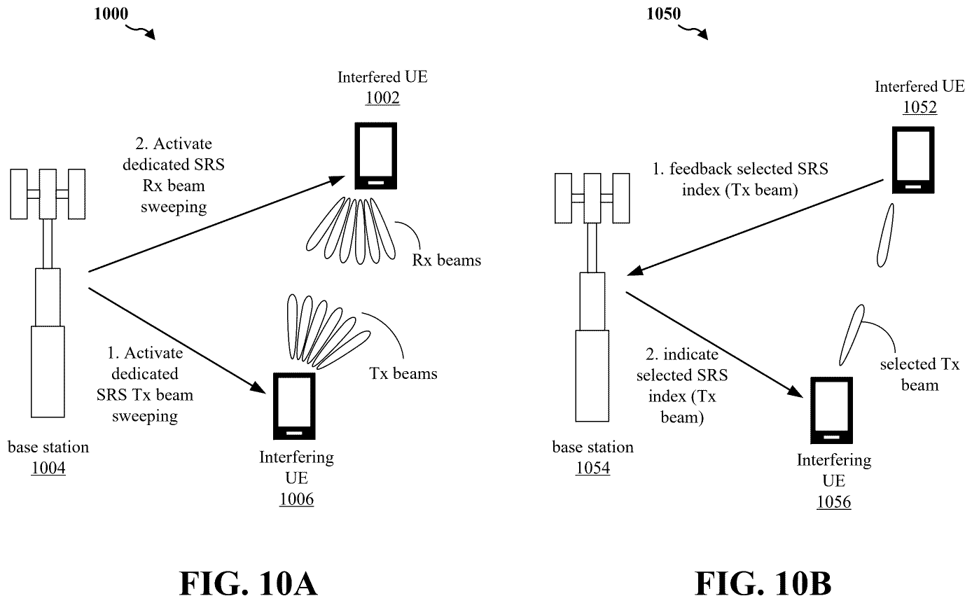

FIG. 10A is a diagram 1000 illustrating an example of dedicated SRS for inter-UE communication (e.g., initial communication setup between different UEs) in accordance with various aspects of the present disclosure. FIG. 10B is a diagram 1050 illustrating another example of dedicated SRS for inter-UE communication in accordance with various aspects of the present disclosure. As shown in FIG. 10A, assuming an interfering UE 1006 is in UL communication with base station 1004 via SRS, a threshold may be configured to the Rx UE (e.g., the interfered UE 1002). If the measured CLI criterion by the interfered UE 1002 is greater than this threshold, the interfered UE 1002 may be triggered to send an SRS report to base station 1004. The CLI criterion may include, for example, one or more of: CLI Reference Signal Received Power (RSRP), CLI Received Signal Strength Indicator (RSSI), or CLI Reference Signal Received Quality (RSRQ). The SRS report may indicate base station 1004 that an interfering UE 1006 is close to the interfered UE 1002 (and may cause CLI interference).

As shown in FIG. 10A, upon receiving the SRS report, base station 1004 may activate, at 1, the interfering UE 1006 to repeatedly perform Tx beam sweeping in configured dedicated SRSs (like on-demand SSB). In some aspects, the dedicated SRS may be transmitted periodically without activation or deactivation from base station 1004. Base station 1004 may activate, at 2, the interfered UE 1002 to perform Rx beam sweeping in those SRSs. The interfered UE 1002 may measure different Rx beams in different SRSs, and report a selected SRS (e.g., the SRS that results in the best measurement result) among the SRSs to base station 1004. In some aspects, instead of reporting the selected SRS to base station 1004, the interfered UE 1002 may give feedback to the interfering UE 1006 directly (e.g., report the selected SRS to the interfering UE 1006). In some aspects, the interfering UE 1006 may be configured from the base station 1004 (e.g., via SRI) or from the interfered UE 1002 to use the selected SRS Tx beam for communication associated with PUCCH/PDCCH. For example, referring to FIG. 10B, the interfered UE 1052 may, at 1, feedback the selected SRS index (which may indicate a Tx beam) to the base station 1054, and the base station 1054 may, at 2, indicate the selected SRS index to the interfering UE 1056. The interfering UE 1056 may communicate with the interfered UE 1052 using the indicated Tx beam.

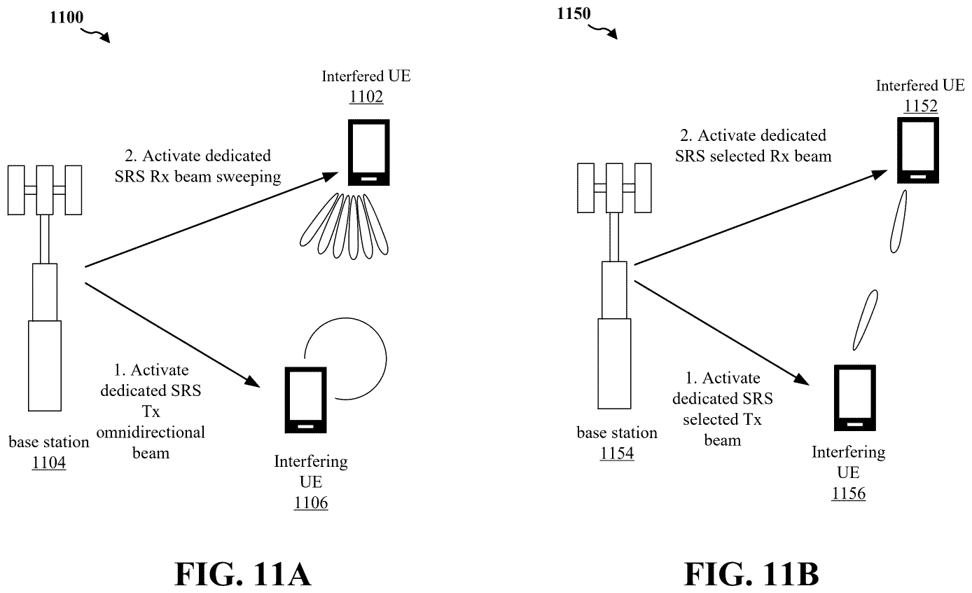

FIG. 11A is diagram 1100 illustrating an example of dedicated SRS for inter-UE communication in accordance with various aspects of the present disclosure. FIG. 11B is diagram 1150 illustrating another example of dedicated SRS for inter-UE communication in accordance with various aspects of the present disclosure. As shown in FIG. 11A, in some aspects, the base station 1104 may activate, at 1, the interfering UE 1106 to transmit dedicated SRS using the omnidirectional beam. The base station 1104 may further activate, at 2, the interfered UE 1102 to perform Rx beam sweeping for the dedicated SRSs. The interfered UE 1102 may measure different Rx beams in different SRSs, and report a selected SRS (e.g., the SRS that results in the best measurement result) among the SRSs to the base station 1104. In some aspects, as shown in FIG. 11B, the base station 1154 may, at 1, activate the interfering UE 1156, to transmit the dedicated SRS using a selected Tx beam, and activate, at 2, the interfered UE 1152 to receive the dedicated SRS using a selected Rx beam.

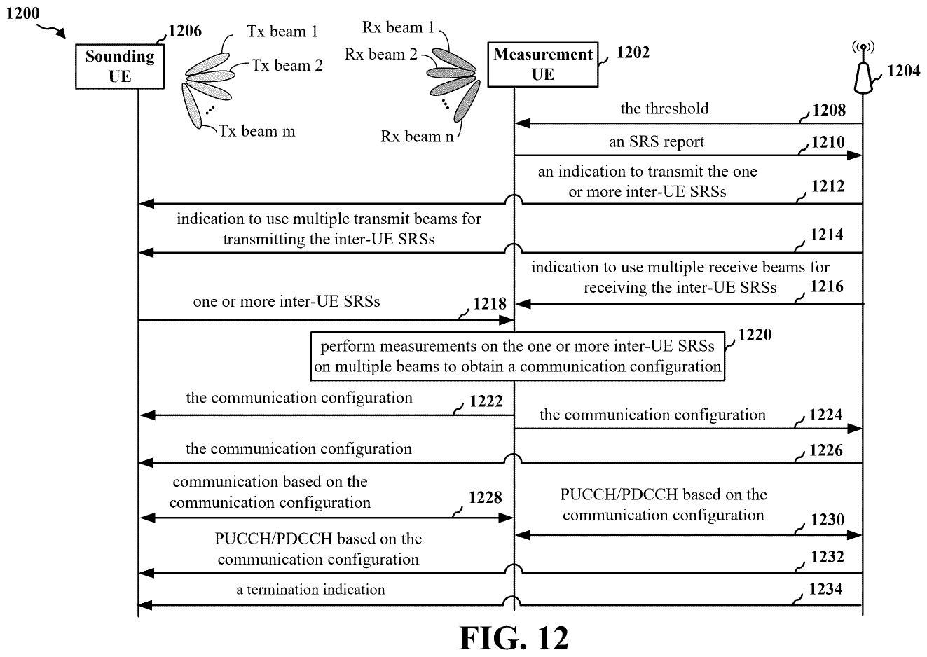

FIG. 12 is a call flow diagram 1200 illustrating a method of wireless communication in accordance with various aspects of this present disclosure. Although aspects are described for a base station 1204, the aspects may be performed by a base station in aggregation and/or by one or more components of a base station 1204 (e.g., such as a CU 110, a DU 130, and/or an RU 140). As shown in FIG. 12, the first UE 1202 may be a measurement UE 1202, which may also be referred to as an Rx UE, and the second UE 1206 may be a sounding UE 1206, which may also be referred as a Tx UE.

As shown in FIG. 12, at 1208, base station 1204 may transmit, to the measurement UE 1202, a threshold for evaluating the CLI.

At 1210, the measurement UE 1202 may transmit to base station 1204 an SRS report. For example, the SRS report may be transmitted to base station 1204 when one of the CLI criteria is higher than the threshold the measurement UE 1202 received at 1208. The CLI criteria may include one or more of the CLI RSRP, the CLI RSSI, or the CLI RSRQ.

At 1212, base station 1204 may transmit to the sounding UE 1206 an indication to transmit the one or more inter-UE SRS. For example, referring to FIG. 10A, the base station 1004 may activate the sounding UE (the interfering UE 1006) to transmit the one or more inter-UE SRSs (the dedicated SRSs).

In some examples, at 1214, base station 1204 may further indicate the sounding UE 1206 to use multiple transmit beams for transmitting the inter-UE SRs. For example, the multiple transmit beams may include Tx beam 1, Tx beam 2, . . . , Tx beam m. For example, referring to FIG. 10A, base station 1004 may activate the sounding UE (the interfering UE 1006) to transmit the one or more inter-UE SRSs (the dedicated SRSs) using multiple transmit beams.

In some examples, at 1216, base station 1204 may indicate the measurement UE 1202 to use multiple receive beams for receiving the inter-UE SRS. For example, the multiple receive beams may include Rx beam 1, Rx beam 2, . . . , Rx beam n. For example, referring to FIG. 10A, the base station 1004 may activate, at 2, the interfered UE 1002 to receive the one or more inter-UE SRSs (the dedicated SRSs) using multiple receive beams.

At 1218, the sounding UE 1206 may transmit one or more inter-UE SRSs to the measurement UE 1202. For example, referring to FIG. 10A, the sounding UE (the interfering UE 1006) may transmit one or more inter-UE SRSs to the measurement UE (the interfered UE 1002).

At 1220, the measurement UE 1202 may perform measurements on the one or more inter-UE SRSs on multiple beams to obtain a communication configuration.

In some examples, at 1222, the measurement UE 1202 may transmit the communication configuration to the sounding UE 1206.

In some examples, the measurement UE 1202 may, at 1224, transmit the communication configuration to base station 1204, and base station 1204 may transmit, at 1226, the communication configuration to the sounding UE 1206. For example, referring to FIG. 10B, the measurement UE (the interfered UE 1052) may transmit, at 1, the communication configuration (the selected Rx index (Tx beam)) to the base station 1054, and the base station 1004 may transmit, at 2, the communication configuration (the selected SRS index (Tx beam)) to the sounding UE (the interfering UE 1056).

At 1228, the sounding UE 1206 and the measurement UE 1202 may communicate based on the communication configuration. For example, referring to FIG. 10B, the sounding UE (the interfering UE 1056) and the measurement UE (the interfered UE 1052) may communicate based on the communication configuration (the selected Tx beam).

In some aspects, at 1230, the measurement UE 1202 may transmit PUCCH to, or receive PDCCH from, base station 1204 based on the communication configuration.

At 1232, the sounding UE 1206 may transmit PUCCH to, or receive PDCCH from, base station 1204 based on the communication configuration.

At 1234, base station 1204 may transmit a termination indication to the sounding UE 1206. Upon receiving the termination indication, the sounding UE 1206 may stop transmitting the inter-UE SRSs.

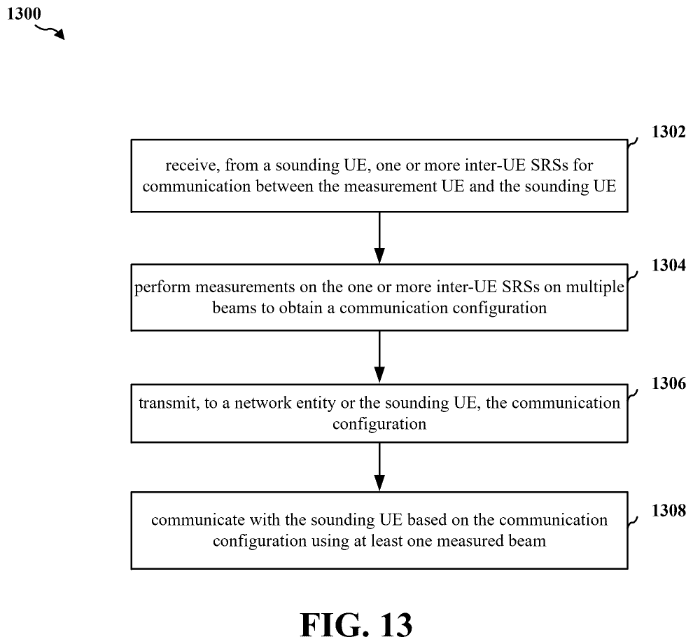

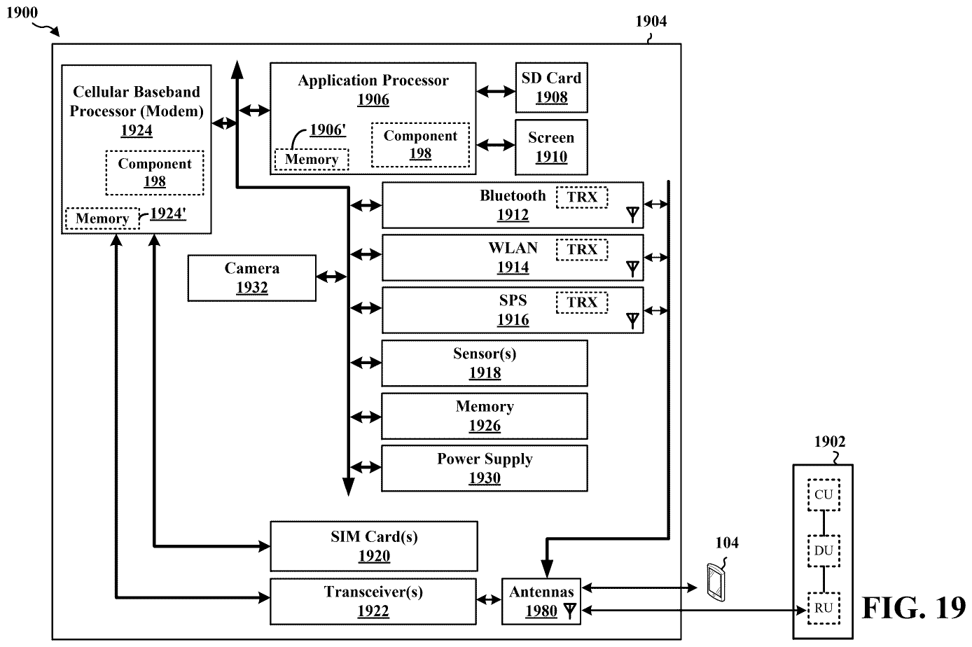

FIG. 13 is a flowchart 1300 illustrating methods of wireless communication at a measurement UE in accordance with various aspects of the present disclosure. The method may be performed by a measurement UE. The measurement UE may be the UE 104, 350, the interfered UE 1002, 1052, 1102, 1152, the measurement UE 1202, or the apparatus 1904 in the hardware implementation of FIG. 19. The method provides dedicated SRSs for inter-UE communication, and the dedicated SRSs may work as the QCL sources for inter-UE communication or DL/UL communication. The method reduces the CLI and improves the efficiency of wireless communication.

As shown in FIG. 13, at 1302, the measurement UE may receive, from a sounding UE, one or more inter-UE SRSs for communication between the measurement UE and the sounding UE. The sounding UE may be the UE 104, 350, the interfering UE 1006, 1056, 1106, 1156, the sounding UE 1206, or the apparatus 1904 in the hardware implementation of FIG. 19. FIGS. 8B, 9B, 10A, 10B, 11A, 11B, and 12 illustrate various aspects of the steps in connection with flowchart 1300. For example, referring to FIG. 12, the measurement UE 1202 may receive, at 1218, from a sounding UE 1206, one or more inter-UE SRSs for communication between the measurement UE 1202 and the sounding UE 1206. In some aspects, 1302 may be performed by the inter-UE SRS component 198.

At 1304, the measurement UE may perform measurements on the one or more inter-UE SRSs on multiple beams to obtain a communication configuration. For example, referring to FIG. 12, the measurement UE 1202 may perform measurements, at 1220, on the one or more inter-UE SRSs on multiple beams to obtain a communication configuration. In some aspects, 1304 may be performed by the inter-UE SRS component 198.

At 1306, the measurement UE may transmit, to a network entity or the sounding UE, the communication configuration. The network entity may be a base station, or a component of a base station, in the access network of FIG. 1 or a core network component (e.g., base station 102, 310, 1004, 1054, 1104, 1154, 1204; or the network entity 1902 in the hardware implementation of FIG. 19). For example, referring to FIG. 12, the measurement UE 1202 may transmit, at 1224 or 1222, to a network entity (base station 1204) or the sounding UE 1206, the communication configuration. In some aspects, 1306 may be performed by the inter-UE SRS component 198.

At 1308, the measurement UE may communicate with the sounding UE based on the communication configuration using at least one measured beam. For example, referring to FIG. 12, the measurement UE 1202 may communicate, at 1228, with the sounding UE 1206 based on the communication configuration using at least one measured beam. In some aspects, 1308 may be performed by the inter-UE SRS component 198.

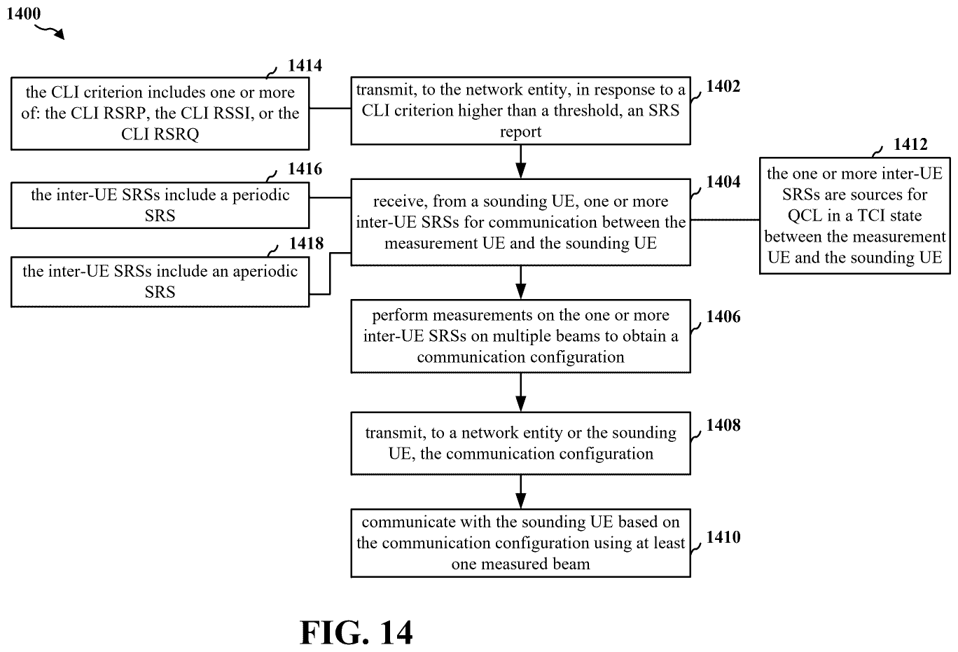

FIG. 14 is a flowchart 1400 illustrating methods of wireless communication at a measurement UE in accordance with various aspects of the present disclosure. The method may be performed by the measurement UE. The measurement UE may be the UE 104, 350, the interfered UE 1002, 1052, 1102, 1152, the measurement UE 1202, or the apparatus 1904 in the hardware implementation of FIG. 19. The method provides dedicated SRSs for inter-UE communication, and the dedicated SRSs may work as the QCL sources for inter-UE communication or DL/UL communication. The method reduces the CLI and improves the efficiency of wireless communication. As shown in FIG. 14, at 1404, the measurement UE may receive, from a sounding UE, one or more inter-UE SRSs for communication between the measurement UE and the sounding UE. The sounding UE may be the UE 104, 350, the interfering UE 1006, 1056, 1106, 1156, the sounding UE 1206, or the apparatus 1904 in the hardware implementation of FIG. 19. FIGS. 8B, 9B, 10A, 10B, 11A, 11B, and 12 illustrate various aspects of the steps in connection with flowchart 1400. For example, referring to FIG. 12, the measurement UE 1202 may receive, at 1218, from a sounding UE 1206, one or more inter-UE SRSs for communication between the measurement UE 1202 and the sounding UE 1206. In some aspects, 1404 may be performed by the inter-UE SRS component 198.

At 1406, the UE may perform measurements on the one or more inter-UE SRSs on multiple beams to obtain a communication configuration. For example, referring to FIG. 12, the measurement UE 1202 may perform measurements, at 1220, on the one or more inter-UE SRSs on multiple beams to obtain a communication configuration. In some aspects, 1406 may be performed by the inter-UE SRS component 198.

At 1408, the measurement UE may transmit, to a network entity or the sounding UE, the communication configuration. The network entity may be a base station, or a component of a base station, in the access network of FIG. 1 or a core network component (e.g., base station 102, 310, 1004, 1054, 1104, 1154, 1204; or the network entity 1902 in the hardware implementation of FIG. 19). For example, referring to FIG. 12, the measurement UE 1202 may transmit, at 1224 or 1222, to a network entity (base station 1204) or the sounding UE 1206, the communication configuration. In some aspects, 1408 may be performed by inter-UE SRS component 198.

At 1410, the measurement UE may communicate with the sounding UE based on the communication configuration using at least one measured beam. For example, referring to FIG. 12, the measurement UE 1202 may communicate, at 1228, with the sounding UE 1206 based on the communication configuration using at least one measured beam. In some aspects, 1410 may be performed by the inter-UE SRS component 198.

In some aspects, at 1412, the one or more inter-UE SRSs may be sources for QCL in a TCI state between the measurement UE and the sounding UE. For example, referring to FIG. 9B, the one or more inter-UE SRSs may be sources for QCL in a TCI state between the measurement UE (the Rx UE 952) and the sounding UE (the Tx UE 956).

In some aspects, the type of the QCL in the TCI state may include one or more: a first type related to the doppler shift, the doppler spread, the average delay, and the delay spread associated with the one or more inter-UE SRSs, a second type related to the doppler shift and the doppler spread associated with the one or more inter-UE SRSs, a third type related to the average delay and the doppler shift associated with the one or more inter-UE SRSs, or a fourth type related to the spatial receive parameter associated with the one or more inter-UE SRSs. For example, referring to FIG. 9B, when the new SRSs work as the sources for QCL, the type of the QCL in the TCI state may include one or more: a first type related to the doppler shift, the doppler spread, the average delay, and the delay spread associated with the one or more inter-UE SRSs, a second type related to the doppler shift and the doppler spread associated with the one or more inter-UE SRSs, a third type related to the average delay and the doppler shift associated with the one or more inter-UE SRSs, or a fourth type related to the spatial receive parameter associated with the one or more inter-UE SRSs.

At 1402, the measurement UE may transmit, to the network entity, in response to a CLI criterion higher than a threshold, an SRS report, and the measurement UE may receive the one or more inter-UE SRS in response to the SRS report. For example, referring to FIG. 12, the measurement UE 1202 may transmit, at 1210, to the network entity (base station 1204), in response to a CLI criterion higher than a threshold, an SRS report, and the measurement UE 1202 may receive, at 1218, the one or more inter-UE SRS in response to the SRS report. In some aspects, 1402 may be performed by the inter-UE SRS component 198.

In some aspects, at 1414, the CLI criterion may include one or more of: the CLI RSRP, the CLI RSSI, or the CLI RSRQ. For example, referring to FIG. 12, when the measurement UE 1202 transmits, at 1210, to the network entity (base station 1204), in response to the CLI criterion higher than a threshold, the SRS report, the CLI criterion may include one or more of: the CLI RSRP, the CLI RSSI, or the CLI RSRQ.

In some aspects, at 1416, the inter-UE SRSs may include a periodic SRS. For example, referring to FIG. 12, the inter-UE SRSs (at 1218) may include a periodic SRS.

In some aspects, at 1418, the inter-UE SRSs may include an aperiodic SRS. For example, referring to FIG. 12, the inter-UE SRSs (at 1218) may include an aperiodic SRS.

In some aspects, the one or more inter-UE SRSs may be respectively associated with multiple transmit beams of the sounding UE. And when receiving the one or more inter-UE SRSs, the measurement UE may receive the one or more inter-UE SRSs respectively via multiple receive beams. For example, referring to FIG. 10A, the one or more inter-UE SRSs may be respectively associated with multiple transmit beams (Tx beams in FIG. 10A) of the sounding UE (the interfering UE 1006). And when receiving the one or more inter-UE SRSs, the measurement UE (the interfered UE 1002) may receive the one or more inter-UE SRSs respectively via multiple receive beams (Rx beams in FIG. 10A).

In some aspects, the communication configuration may indicate a selected transmit beam from the multiple transmit beams. For example, referring to FIG. 10B, the communication configuration may indicate a selected transmit beam (the selected Tx beam in FIG. 10B) from the multiple transmit beams.

In some aspects, when communicating with the sounding UE, the measurement UE may communicate with the sounding UE using the selected transmit beam. For example, referring to FIG. 10B, the measurement UE (the interfered UE 1052) may communicate with the sounding UE (the interfering UE 1056) using the selected transmit beam (the selected Tx beam in FIG. 10B).

In some aspects, a first BWP for the one or more inter-UE SRSs may be different from a second BWP for a connection between the network entity and the measurement UE. For example, referring to FIG. 12, the first BWP for the one or more inter-UE SRSs (at 1218) may be different from the second BWP for a connection between the network entity (base station 1204) and the measurement UE 1202.

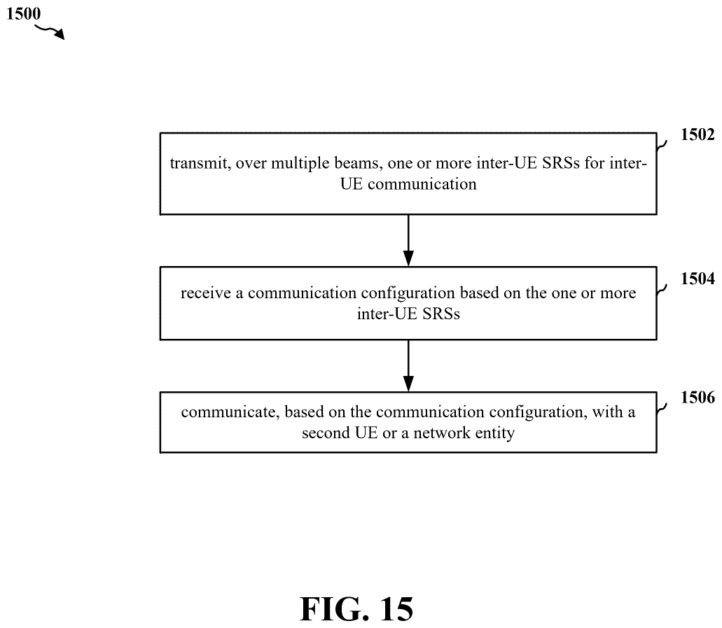

FIG. 15 is a flowchart 1500 illustrating methods of wireless communication at a sounding UE in accordance with various aspects of the present disclosure. The method may be performed by the sounding UE. The sounding UE may be the UE 104, 350, the interfering UE 1006, 1056, 1106, 1156, the sounding UE 1206, or the apparatus 1904 in the hardware implementation of FIG. 19. The method provides dedicated SRSs for inter-UE communication, and the dedicated SRSs may work as the QCL sources for inter-UE communication or DL/UL communication. The method reduces the CLI and improves the efficiency of wireless communication.

As shown in FIG. 15, at 1502, the sounding UE may transmit, over multiple beams, one or more inter-UE SRSs for inter-UE communication. FIGS. 8B, 9B, 10A, 10B, 11A, 11B, and 12 illustrate various aspects of the steps in connection with flowchart 1500. For example, referring to FIG. 12, the sounding UE 1206 may transmit, at 1218, over multiple beams, one or more inter-UE SRSs for inter-UE communication. Referring to FIG. 10A, the sounding UE (e.g., 1006) may transmit, over multiple beams (Tx beams), one or more inter-UE SRSs for inter-UE communication. In some aspects, 1502 may be performed by the inter-UE SRS component 198.

At 1504, the sounding UE may receive a communication configuration based on the one or more inter-UE SRSs. For example, referring to FIG. 12, the sounding UE 1206 may receive, at 1222, a communication configuration based on the one or more inter-UE SRSs. In some aspects, 1504 may be performed by the inter-UE SRS component 198.

At 1506, the sounding UE may communicate, based on the communication configuration, with a second UE or a network entity. The second UE may be the UE 104, 350, the interfered UE 1002, 1052, 1102, 1152, the measurement UE 1202, or the apparatus 1904 in the hardware implementation of FIG. 19. The network entity may be a base station, or a component of a base station, in the access network of FIG. 1 or a core network component (e.g., base station 102, 310, 1004, 1054, 1104, 1154, 1204; or the network entity 1902 in the hardware implementation of FIG. 19). For example, referring to FIG. 12, the sounding UE 1206 may communicate, at 1228, based on the communication configuration, with a second UE (the measurement UE 1202) or a network entity. In some aspects, 1506 may be performed by the inter-UE SRS component 198.

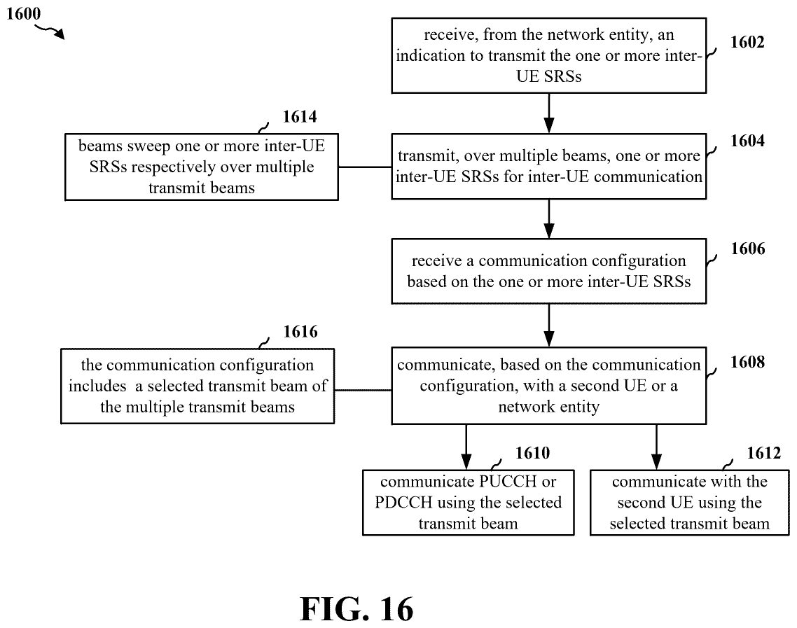

FIG. 16 is a flowchart 1600 illustrating methods of wireless communication at a sounding UE in accordance with various aspects of the present disclosure. The method may be performed by the sounding UE. The sounding UE may be the UE 104, 350, the interfering UE 1006, 1056, 1106, 1156, the sounding UE 1206, or the apparatus 1904 in the hardware implementation of FIG. 19. The method provides dedicated SRSs for inter-UE communication, and the dedicated SRSs may work as the QCL sources for inter-UE communication or DL/UL communication. The method reduces the CLI and improves the efficiency of wireless communication.

As shown in FIG. 16, at 1604, the sounding UE may transmit, over multiple beams, one or more inter-UE SRSs for inter-UE communication. FIGS. 8B, 9B, 10A, 10B, 11A, 11B, and 12 illustrate various aspects of the steps in connection with flowchart 1600. For example, referring to FIG. 12, the sounding UE 1206 may transmit, at 1218, over multiple beams, one or more inter-UE SRSs for inter-UE communication. Referring to FIG. 10A, the sounding UE (e.g., 1006) may transmit, over multiple beams (Tx beams), one or more inter-UE SRSs for inter-UE communication. In some aspects, 1604 may be performed by the inter-UE SRS component 198.

At 1606, the sounding UE may receive a communication configuration based on the one or more inter-UE SRSs. For example, referring to FIG. 12, the sounding UE 1206 may receive, at 1222, a communication configuration based on the one or more inter-UE SRSs. In some aspects, 1606 may be performed by the inter-UE SRS component 198.

At 1608, the sounding UE may communicate, based on the communication configuration, with a second UE or a network entity. The second UE may be the UE 104, 350, the interfered UE 1002, 1052, 1102, 1152, the measurement UE 1202, or the apparatus 1904 in the hardware implementation of FIG. 19. The network entity may be a base station, or a component of a base station, in the access network of FIG. 1 or a core network component (e.g., base station 102, 310, 1004, 1054, 1104, 1154, 1204; or the network entity 1902 in the hardware implementation of FIG. 19). For example, referring to FIG. 12, the sounding UE 1206 may communicate, at 1228, based on the communication configuration, with a second UE (the measurement UE 1202) or a network entity. In some aspects, 1608 may be performed by the inter-UE SRS component 198.

At 1602, the sounding UE may receive, from the network entity, an indication to transmit the one or more inter-UE SRSs. And, when transmitting the one or more inter-UE SRSs at 1604, the sounding UE may transmit, in response to the indication, the one or more inter-UE SRSs. For example, referring to FIG. 12, the sounding UE 1206 may receive, at 1212, from the network entity (base station 1204), an indication to transmit the one or more inter-UE SRSs. When transmitting the one or more inter-UE SRSs at 1218, the sounding UE 1206 may transmit, in response to the indication, the one or more inter-UE SRSs. In some aspects, 1602 may be performed by the inter-UE SRS component 198.

In some aspects, when receiving the communication configuration based on the one or more inter-UE SRSs at 1606, the sounding UE may receive the communication configuration from the network entity. For example, referring to FIG. 12, the sounding UE 1206 may receive, at 1226, the communication configuration from the network entity (base station 1204). Referring to FIG. 10B, the sounding UE (the interfering UE 1056) may receive, at 2, the communication configuration from the network entity (base station 1054).

In some aspects, when receiving the communication configuration based on the one or more inter-UE SRSs at 1606, the sounding UE may receive the communication configuration from the second UE. For example, referring to FIG. 12, the sounding UE 1206 may receive, at 1222, the communication configuration from the second UE (the measurement UE 1202).

In some aspects, at 1614, when transmitting the one or more inter-UE SRSs at 1604, the sounding UE may beams sweep one or more inter-UE SRSs respectively over multiple transmit beams. For example, referring to FIG. 10A, the sounding UE (the interfering UE 1006) may beams sweep one or more inter-UE SRSs respectively over multiple transmit beams (Tx beams).

In some aspects, at 1616, the communication configuration may include a selected transmit beam of the multiple transmit beams. For example, referring to FIG. 10B, the communication configuration may include a selected transmit beam (the selected Tx beam) of the multiple transmit beams.

At 1610, the sounding UE may communicate PUCCH or PDCCH using the selected transmit beam. For example, referring to FIG. 12, the sounding UE 1206 may communicate, at 1232, PUCCH or PDCCH using the selected transmit beam. In some aspects, 1610 may be performed by the inter-UE SRS component 198.

At 1612, the sounding UE may communicate with the second UE using the selected transmit beam. For example, referring to FIG. 10B, the sounding UE (the interfering UE 1056) may communicate with the second UE (the interfered UE 1052) using the selected transmit beam (the selected Tx beam). In some aspects, 1612 may be performed by the inter-UE SRS component 198.

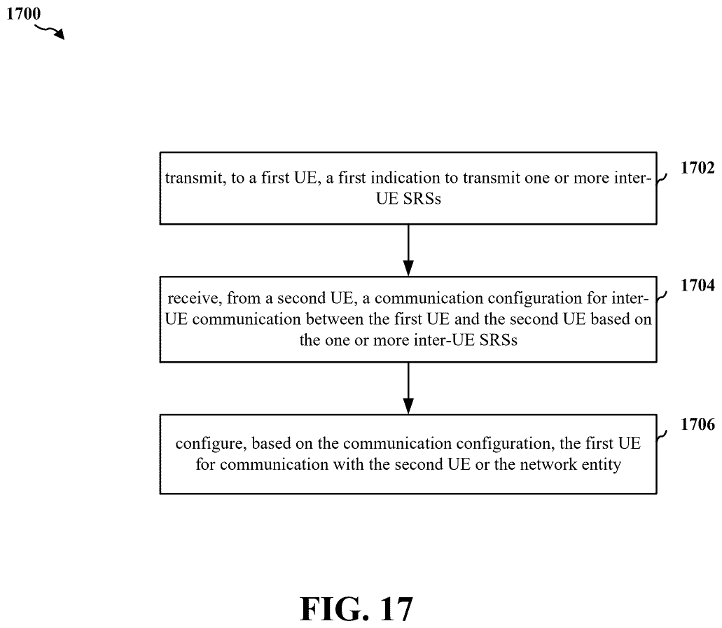

FIG. 17 is a flowchart 1700 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1004, 1054, 1104, 1154, 1204; or the network entity 1902 in the hardware implementation of FIG. 19). The method provides dedicated SRSs for inter-UE communication, and the dedicated SRSs may work as the QCL sources for inter-UE communication or DL/UL communication. The method reduces the CLI and improves the efficiency of wireless communication.

As shown in FIG. 17, at 1702, the network entity may transmit, to a first UE, a first indication to transmit one or more inter-UE SRSs. The first UE may be the UE 104, 350, the interfering UE 1006, 1056, 1106, 1156, the sounding UE 1206, or the apparatus 1904 in the hardware implementation of FIG. 19. FIGS. 8B, 9B, 10A, 10B, 11A, 11B, and 12 illustrate various aspects of the steps in connection with flowchart 1700. For example, referring to FIG. 12, the network entity (base station 1204) may transmit, at 1212, to a first UE (the sounding UE 1206), a first indication to transmit one or more inter-UE SRSs. In some aspects, 1702 may be performed by the inter-UE SRS component 199.

At 1704, the network entity may receive, from a second UE, a communication configuration for inter-UE communication between the first UE and the second UE based on the one or more inter-UE SRSs. The second UE may be the UE 104, 350, the interfered UE 1002, 1052, 1102, 1152, the measurement UE 1202, or the apparatus 1904 in the hardware implementation of FIG. 19. For example, referring to FIG. 12, the network entity (base station 1204) may receive, at 1224, from a second UE (the measurement UE 1202), a communication configuration for inter-UE communication between the first UE (the sounding UE 1206) and the second UE (the measurement UE 1202) based on the one or more inter-UE SRSs. In some aspects, 1704 may be performed by the inter-UE SRS component 199.

At 1706, the network entity may configure, based on the communication configuration, the first UE for communication with the second UE or the network entity. For example, referring to FIG. 12, the network entity (base station 1204) may configure, at 1226, based on the communication configuration, the first UE (the sounding UE 1206) for communication with the second UE (the measurement UE 1202) or the network entity (base station 1204). In some aspects, 1706 may be performed by the inter-UE SRS component 199.

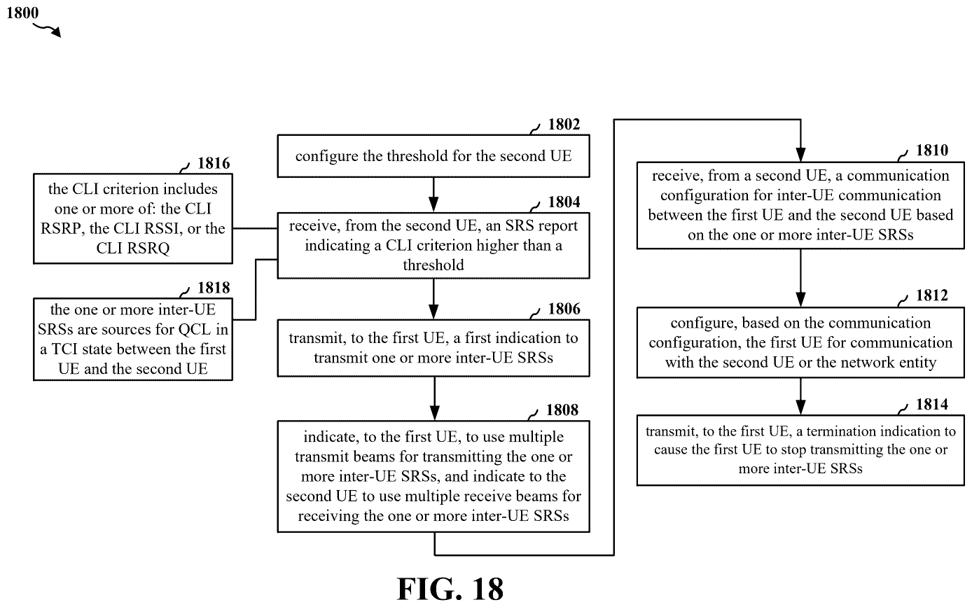

FIG. 18 is a flowchart 1800 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1004, 1054, 1104, 1154, 1204; or the network entity 1902 in the hardware implementation of FIG. 19). The method provides dedicated SRSs for inter-UE communication, and the dedicated SRSs may work as the QCL sources for inter-UE communication or DL/UL communication. The method reduces the CLI and improves the efficiency of wireless communication.

As shown in FIG. 18, at 1806, the network entity may transmit, to the first UE, a first indication to transmit one or more inter-UE SRSs. The first UE may be the UE 104, 350, the interfering UE 1006, 1056, 1106, 1156, the sounding UE 1206, or the apparatus 1904 in the hardware implementation of FIG. 19. FIGS. 8B, 9B, 10A, 10B, 11A, 11B, and 12 illustrate various aspects of the steps in connection with flowchart 1800. For example, referring to FIG. 12, the network entity (base station 1204) may transmit, at 1212, to a first UE (the sounding UE 1206), a first indication to transmit one or more inter-UE SRSs. In some aspects, 1806 may be performed by the inter-UE SRS component 199.

At 1810, the network entity may receive, from a second UE, a communication configuration for inter-UE communication between the first UE and the second UE based on the one or more inter-UE SRSs. The second UE may be the UE 104, 350, the interfered UE 1002, 1052, 1102, 1152, the measurement UE 1202, or the apparatus 1904 in the hardware implementation of FIG. 19. For example, referring to FIG. 12, the network entity (base station 1204) may receive, at 1224, from a second UE (the measurement UE 1202), a communication configuration for inter-UE communication between the first UE (the sounding UE 1206) and the second UE (the measurement UE 1202) based on the one or more inter-UE SRSs. In some aspects, 1810 may be performed by the inter-UE SRS component 199.

At 1812, the network entity may configure, based on the communication configuration, the first UE for communication with the second UE or the network entity. For example, referring to FIG. 12, the network entity (base station 1204) may configure, at 1226, based on the communication configuration, the first UE (the sounding UE 1206) for communication with the second UE (the measurement UE 1202) or the network entity (base station 1204). In some aspects, 1812 may be performed by the inter-UE SRS component 199.

At 1804, the network entity may receive, from the second UE, an SRS report indicating a CLI criterion higher than a threshold. And when transmitting the first indication to transmit the one or more inter-UE SRSs, the network entity may transmit, in response to the SRS report, the first indication to transmit the one or more inter-UE SRSs. For example, referring to FIG. 12, the network entity (base station 1204) may receive, at 1210, from the second UE (the measurement UE 1202), an SRS report indicating a CLI criterion higher than a threshold. And when transmitting the first indication (at 1212), the network entity (base station 1204) may transmit, at 1212, in response to the SRS report, the first indication to transmit the one or more inter-UE SRSs. In some aspects, 1804 may be performed by the inter-UE SRS component 199. At 1802, the network entity may configure the threshold for the second UE. For example, referring to FIG. 12, the network entity (base station 1204) may configure, at 1208, the threshold for the second UE (the measurement UE 1202). In some aspects, 1802 may be performed by the inter-UE SRS component 199.

In some aspects, at 1816, the CLI criterion may include one or more of: the CLI RSRP, the CLI RSSI, or the CLI RSRQ. For example, referring to FIG. 12, when the measurement UE 1202 transmits, at 1210, to the network entity (base station 1204), in response to the CLI criterion higher than a threshold, the SRS report, the CLI criterion may include one or more of: the CLI RSRP, the CLI RSSI, or the CLI RSRQ.

In some aspects, at 1818, the one or more inter-UE SRSs may be sources for QCL in a TCI state between the first UE and the second UE. For example, referring to FIG. 9B, the one or more inter-UE SRSs may be sources for QCL in a TCI state between the first UE (the Tx UE 956) and the second UE (the Rx UE 952).

In some aspects, the type of the QCL in the TCI state may include one or more: a first type related to the doppler shift, the doppler spread, the average delay, and the delay spread associated with the one or more inter-UE SRSs, a second type related to the doppler shift and the doppler spread associated with the one or more inter-UE SRSs, a third type related to the average delay and the doppler shift associated with the one or more inter-UE SRSs, or a fourth type related to the spatial receive parameter associated with the one or more inter-UE SRSs. For example, referring to FIG. 9B, when the new SRSs work as the sources for QCL, the type of the QCL in the TCI state may include one or more: a first type related to the doppler shift, the doppler spread, the average delay, and the delay spread associated with the one or more inter-UE SRSs, a second type related to the doppler shift and the doppler spread associated with the one or more inter-UE SRSs, a third type related to the average delay and the doppler shift associated with the one or more inter-UE SRSs, or a fourth type related to the spatial receive parameter associated with the one or more inter-UE SRSs.

At 1808, the network entity may indicate, to the first UE, to use multiple transmit beams for transmitting the one or more inter-UE SRSs, and indicate to the second UE to use multiple receive beams for receiving the one or more inter-UE SRSs. For example, referring to FIG. 10A, the network entity (base station 1004) may indicate, at 1, to the first UE (the interfering UE 1006), to use multiple transmit beams (Tx beams) for transmitting the one or more inter-UE SRSs, and indicate to the second UE (the interfered UE 1002) to use multiple receive beams (Rx beams) for receiving the one or more inter-UE SRSs. In some aspects, 1808 may be performed by the inter-UE SRS component 199.

In some aspects, the communication configuration may indicate one transmit beam from the multiple transmit beams of the first UE. And to configure the first UE at 1812, the network entity may configure the first UE to use the one transmit beam for PUCCH or PDCCH or for communication with the second UE. For example, referring to FIG. 10B, the communication configuration may indicate one transmit beam (the selected Tx beam) from the multiple transmit beams of the first UE (the interfering UE 1056).

In some aspects, a first BWP for the one or more inter-UE SRSs may be different from a second BWP for a connection between the network entity and the first UE. For example, referring to FIG. 12, the first BWP for the one or more inter-UE SRSs (at 1218) may be different from the second BWP for a connection between the network entity (base station 1204) and the first UE (the sounding UE 1206).

At 1814, the network entity may transmit, to the first UE, a termination indication to cause the first UE to stop transmitting the one or more inter-UE SRSs. For example, referring to FIG. 12, the network entity (base station 1204) may transmit, at 1234, to the first UE (the sounding UE 1206), a termination indication to cause the first UE to stop transmitting the one or more inter-UE SRSs. In some aspects, 1814 may be performed by the inter-UE SRS component 199.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see UE 350 of FIG. 3) and include the additional modules of the apparatus 1904.

As discussed supra, in some aspects, the component 198 may be configured to receive, from a sounding UE, one or more inter-UE SRSs for communication between the measurement UE and the sounding UE; perform measurements on the one or more inter-UE SRSs on multiple beams to obtain a communication configuration; transmit, to a network entity or the sounding UE, the communication configuration; and communicate with the sounding UE based on the communication configuration using at least one measured beam. In some aspects, the component 198 may be configured to transmit, over multiple beams, one or more inter-UE SRSs for inter-UE communication; receive a communication configuration based on the one or more inter-UE SRSs; and communicate, based on the communication configuration, with a second UE or a network entity. The component 198 may be further configured to perform any of the aspects described in connection with the flowcharts in FIG. 13, FIG. 14, FIG. 15, and FIG. 16, and/or performed by the UE 1202 or the UE 1206 in FIG. 12. The component 198 may be within the cellular baseband processor 1924, the application processor 1906, or both the cellular baseband processor 1924 and the application processor 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for receiving, from a sounding UE, one or more inter-UE SRSs for communication between the measurement UE and the sounding UE, means for performing measurements on the one or more inter-UE SRSs on multiple beams to obtain a communication configuration, means for transmitting, to a network entity or the sounding UE, the communication configuration, and means for communicating with the sounding UE based on the communication configuration using at least one measured beam. In one configuration, the apparatus 1904, and in particular the cellular baseband processor 1924 and/or the application processor 1906, includes means for transmitting, over multiple beams, one or more inter-UE SRSs for inter-UE communication, means for receiving a communication configuration based on the one or more inter-UE SRSs, and means for communicating, based on the communication configuration, with a second UE or a network entity. The apparatus 1904 may further include means for performing any of the aspects described in connection with the flowcharts in FIG. 13, FIG. 14, FIG. 15, and FIG. 16, and/or aspects performed by the UE 1202 or the UE 1206 in FIG. 12. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

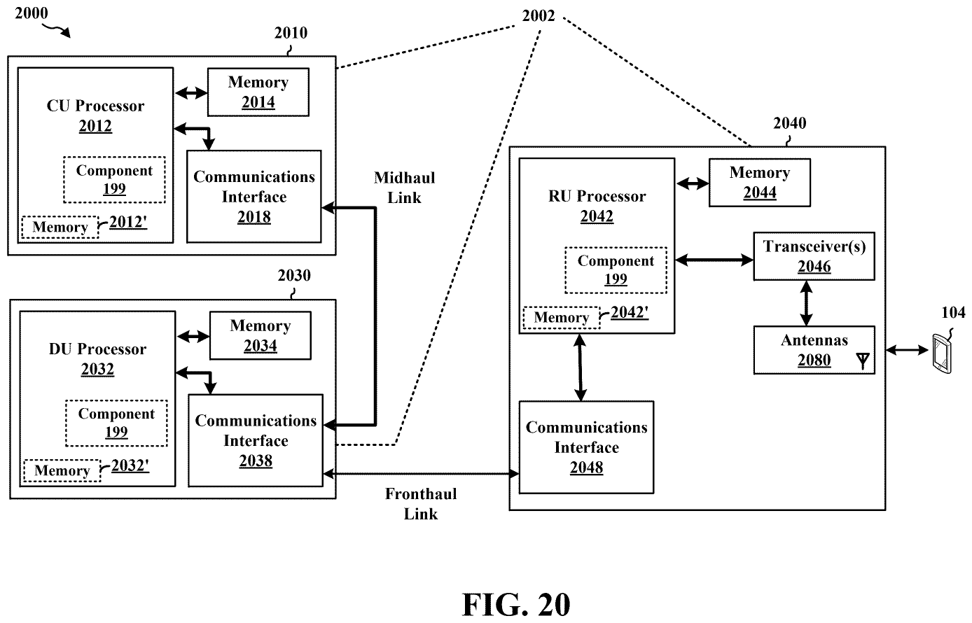

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a first UE, a first indication to transmit one or more inter-UE SRSs; receive, from a second UE, a communication configuration for inter-UE communication between the first UE and the second UE based on the one or more inter-UE SRSs; and configure, based on the communication configuration, the first UE for communication with the second UE or the network entity. The component 199 may be further configured to perform any of the aspects described in connection with the flowcharts in FIG. 17 and FIG. 18, and/or performed by base station 1204 in FIG. 12. The component 199 may be within one or more processors of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for transmitting, to a first UE, a first indication to transmit one or more inter-UE SRSs, means for receiving, from a second UE, a communication configuration for inter-UE communication between the first UE and the second UE based on the one or more inter-UE SRSs, and means for configuring, based on the communication configuration, the first UE for communication with the second UE or the network entity. The network entity 2002 may further include means for performing any of the aspects described in connection with the flowcharts in FIG. 17 and FIG. 18, and/or aspects performed by base station 1204 in FIG. 12. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means. This disclosure provides a method for wireless communication at a measurement UE. The method may include receiving, from a sounding UE, one or more inter-UE SRSs for communication between the measurement UE and the sounding UE; performing measurements on the one or more inter-UE SRSs on multiple beams to obtain a communication configuration; transmitting, to a network entity or the sounding UE, the communication configuration; and communicating with the sounding UE based on the communication configuration using at least one measured beam. The method provides dedicated SRSs for inter-UE communication, and the dedicated SRSs may work as the QCL sources for inter-UE communication or DL/UL communication. The method reduces the CLI and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a measurement UE. The method may include receiving, from a sounding UE, one or more inter-UE SRSs for communication between the measurement UE and the sounding UE; performing measurements on the one or more inter-UE SRSs on multiple beams to obtain a communication configuration; transmitting, to a network entity or the sounding UE, the communication configuration; and communicating with the sounding UE based on the communication configuration using at least one measured beam.

Aspect 2 is the method of aspect 1, where the one or more inter-UE SRSs may be sources for QCL in a TCI state between the measurement UE and the sounding UE.

Aspect 3 is the method of aspect 2, where the type of the QCL in the TCI state may include one or more: the first type related to the doppler shift, the doppler spread, the average delay, and the delay spread associated with the one or more inter-UE SRSs, the second type related to the doppler shift and the doppler spread associated with the one or more inter-UE SRSs, the third type related to the average delay and the doppler shift associated with the one or more inter-UE SRSs, or the fourth type related to the spatial receive parameter associated with the one or more inter-UE SRSs.

Aspect 4 is the method of any of aspects 1 to 3, where the method may further include: prior to receiving the one or more inter-UE SRSs: transmitting, to the network entity, in response to a CLI criterion higher than a threshold, an SRS report. And receiving the one or more inter-UE SRSs may include: receiving the one or more inter-UE SRS in response to the SRS report.

Aspect 5 is the method of aspect 4, where the CLI criterion may include one or more of: the CLI RSRP, the CLI RSSI, or the CLI RSRQ.

Aspect 6 is the method of any of aspects 1 to 5, where the inter-UE SRSs may include a periodic SRS.

Aspect 7 is the method of any of aspects 1 to 5, where the inter-UE SRSs may include an aperiodic SRS.

Aspect 8 is the method of any of aspects 1 to 7, where the one or more inter-UE SRSs may be respectively associated with multiple transmit beams of the sounding UE. And receiving the one or more inter-UE SRSs may include: receiving the one or more inter-UE SRSs respectively via multiple receive beams of the measurement UE.

Aspect 9 is the method of aspect 8, where the communication configuration may indicate a selected transmit beam from the multiple transmit beams.

Aspect 10 is the method of aspect 9, where communicating with the sounding UE may include: communicating with the sounding UE using the selected transmit beam.

Aspect 11 is the method of any of aspects 1 to 10, where a first BWP for the one or more inter-UE SRSs is different from a second BWP for a connection between the network entity and the measurement UE.

Aspect 12 is an apparatus for wireless communication at a UE, including: a memory; and at least one processor coupled to the memory and, based at least in part on information stored in the memory, the at least one processor is configured to perform the method of any of aspects 1-11.

Aspect 13 is the apparatus of aspect 12, further including at least one of a transceiver or an antenna coupled to the at least one processor and configured to receive the one or more inter-UE SRSs.

Aspect 14 is an apparatus for wireless communication including means for implementing the method of any of aspects 1-11.

Aspect 15 is a computer-readable medium (e.g., a non-transitory computer-readable medium) storing computer executable code, where the code when executed by a processor causes the processor to implement the method of any of aspects 1-11.

Aspect 16 is a method of wireless communication at a sounding UE. The method may include transmitting, over multiple beams, one or more inter-UE SRSs for inter-UE communication; receiving a communication configuration based on the one or more inter-UE SRSs; and communicating, based on the communication configuration, with a second UE or a network entity.

Aspect 17 is the method of aspect 16, where the method may further include, prior to transmitting the one or more inter-UE SRSs: receiving, from the network entity, an indication to transmit the one or more inter-UE SRSs. And transmitting the one or more inter-UE SRSs may include: transmitting, in response to the indication, the one or more inter-UE SRSs.

Aspect 18 is the method of any of aspects 16 to 17, where receiving the communication configuration based on the one or more inter-UE SRSs may include: receiving, from the network entity, the communication configuration based on the one or more inter-UE SRSs.

Aspect 19 is the method of any of aspects 16 to 17, where receiving the communication configuration based on the one or more inter-UE SRSs may include: receiving, from the second UE, the communication configuration based on the one or more inter-UE SRSs.

Aspect 20 is the method of any of aspects 17 to 19, where transmitting the one or more inter-UE SRSs may include: beams sweeping one or more inter-UE SRSs respectively over multiple transmit beams.

Aspect 21 is the method of aspect 20, where the communication configuration may include a selected transmit beam of the multiple transmit beams.

Aspect 22 is the method of aspect 21, where the method may further include: communicating PUCCH or PDCCH using the selected transmit beam.

Aspect 23 is the method of aspect 21, where the method may further include: communicating with the second UE using the selected transmit beam.

Aspect 24 is an apparatus for wireless communication at a network entity, including: a memory; and at least one processor coupled to the memory and, based at least in part on information stored in the memory, the at least one processor is configured to perform the method of any of aspects 16-23.

Aspect 25 is the apparatus of aspect 24, further including at least one of a transceiver or an antenna coupled to the at least one processor and configured to transmit the one or more inter-UE SRSs.

Aspect 26 is an apparatus for wireless communication including means for implementing the method of any of aspects 16-23.

Aspect 27 is a computer-readable medium (e.g., a non-transitory computer-readable medium) storing computer executable code, where the code when executed by a processor causes the processor to implement the method of any of aspects 16-23.

Aspect 28 is a method of wireless communication at a network entity. The method may include transmitting, to a first UE, a first indication to transmit one or more inter-UE SRSs; receiving, from a second UE, a communication configuration for inter-UE communication between the first UE and the second UE based on the one or more inter-UE SRSs; and configuring, based on the communication configuration, the first UE for communication with the second UE or the network entity.

Aspect 29 is the method of aspect 28, where the method may further include: receiving, from the second UE, an SRS report indicating a CLI criterion higher than a threshold. And transmitting first the indication to transmit the one or more inter-UE SRSs may include: transmitting, in response to the SRS report, the first indication to transmit the one or more inter-UE SRSs.

Aspect 30 is the method of aspect 29, where the method may further include: prior to receiving the SRS report, configuring the threshold for the second UE.

Aspect 31 is the method of any of aspects 29 to 30, where the CLI criterion may include one or more of: the CLI RSRP, the CLI RSSI, or the CLI RSRQ.

Aspect 32 is the method of aspect 29, where the one or more inter-UE SRSs may be sources for QCL in a TCI state between the first UE and the second UE.

Aspect 33 is the method of aspect 32, where the type of the QCL in the TCI state may include one or more: the first type related to the doppler shift, the doppler spread, the average delay, and the delay spread associated with the one or more inter-UE SRSs, the second type related to the doppler shift and the doppler spread associated with the one or more inter-UE SRSs, the third type related to the average delay and the doppler shift associated with the one or more inter-UE SRSs, or the fourth type related to the spatial receive parameter associated with the one or more inter-UE SRSs.

Aspect 34 is the method of any of aspects 28 to 33, where the method may further include indicating, to the first UE, to use multiple transmit beams for transmitting the one or more inter-UE SRSs, and indicating, to the second UE, to use multiple receive beams for receiving the one or more inter-UE SRSs.

Aspect 35 is the method of aspect 34, where the communication configuration may indicate one transmit beam from the multiple transmit beams of the first UE. And configuring the first UE may include: configuring the first UE to use the one transmit beam for PUCCH or PDCCH or for communication with the second UE.

Aspect 36 is the method of any of aspects 28 to 35, where a first BWP for the one or more inter-UE SRSs may be different from a second BWP for a connection between the network entity and the first UE.

Aspect 37 is the method of any of aspects 28 to 36, where the method may further include transmitting, to the first UE, a termination indication to cause the first UE to stop transmitting the one or more inter-UE SRSs.

Aspect 38 is an apparatus for wireless communication at a network entity, including: a memory; and at least one processor coupled to the memory and, based at least in part on information stored in the memory, the at least one processor is configured to perform the method of any of aspects 28-37.

Aspect 39 is the apparatus of aspect 38, further including at least one of a transceiver or an antenna coupled to the at least one processor and configured to transmit the first indication.

Aspect 40 is an apparatus for wireless communication including means for implementing the method of any of aspects 28-37.

Aspect 41 is a computer-readable medium (e.g., a non-transitory computer-readable medium) storing computer executable code, where the code when executed by a processor causes the processor to implement the method of any of aspects 28-37.

1. An apparatus for wireless communication at a measurement user equipment (UE), comprising:
memory; and
at least one processor coupled to the memory and, based at least in part on information stored in the memory, the at least one processor is configured to:
receive, from a sounding UE, one or more inter-UE Sounding Reference Signals (SRSs) for communication between the measurement UE and the sounding UE;
perform measurements on the one or more inter-UE SRSs on multiple beams to obtain a communication configuration;
transmit, to a network entity or the sounding UE, the communication configuration; and
communicate with the sounding UE based on the communication configuration using at least one measured beam.

2. The apparatus of claim 1, further comprising a transceiver coupled to the at least one processor, wherein, to receive the one or more inter-UE SRSs, the at least one processor is configured to receive the one or more inter-UE SRSs via the transceiver, and wherein the one or more inter-UE SRSs are sources for Quasi Co-Location (QCL) in a transmission configuration indication (TCI) state between the measurement UE and the sounding UE.

3. The apparatus of claim 2, wherein a type of the QCL in the TCI state includes one or more:
a first type related to a doppler shift, a doppler spread, an average delay, and a delay spread associated with the one or more inter-UE SRSs,
a second type related to the doppler shift and the doppler spread associated with the one or more inter-UE SRSs,
a third type related to the average delay and the doppler shift associated with the one or more inter-UE SRSs, or
a fourth type related to a spatial receive parameter associated with the one or more inter-UE SRSs.

4. The apparatus of claim 1, wherein the at least one processor is further configured to, prior to being configured to receive the one or more inter-UE SRSs:
transmit, to the network entity, in response to a cross-link interference (CLI) criterion higher than a threshold, an SRS report, wherein, to receive the one or more inter-UE SRSs, the at least one processor is configured to:
receive the one or more inter-UE SRS in response to the SRS report.

5. The apparatus of claim 4, wherein the CLI criterion includes one or more of:
a CLI Reference Signal Received Power (RSRP),
a CLI Received Signal Strength Indicator (RSSI), or
a CLI Reference Signal Received Quality (RSRQ).

6. The apparatus of claim 1, wherein the inter-UE SRSs comprise a periodic SRS.

7. The apparatus of claim 1, wherein the inter-UE SRSs comprise an aperiodic SRS.

8. The apparatus of claim 1, wherein the one or more inter-UE SRSs are respectively associated with multiple transmit beams of the sounding UE, and wherein, to receive the one or more inter-UE SRSs, the at least one processor is configured to:
receive the one or more inter-UE SRSs respectively via multiple receive beams of the measurement UE.

9. The apparatus of claim 8, wherein the communication configuration indicates a selected transmit beam from the multiple transmit beams.

10. The apparatus of claim 9, wherein, to communicate with the sounding UE, the at least one processor is configured to:
communicate with the sounding UE using the selected transmit beam.

11. The apparatus of claim 1, wherein a first bandwidth part (BWP) for the one or more inter-UE SRSs is different from a second BWP for a connection between the network entity and the measurement UE.

12. An apparatus of wireless communication at a sounding user equipment (UE), comprising:
memory; and
at least one processor coupled to the memory and, based at least in part on information stored in the memory, the at least one processor is configured to:
transmit, over multiple beams, one or more inter-UE Sounding Reference Signals (SRSs) for inter-UE communication;
receive a communication configuration based on the one or more inter-UE SRSs; and
communicate, based on the communication configuration, with a second UE or a network entity.

13. The apparatus of claim 12, wherein the at least one processor is further configured to, prior to transmitting the one or more inter-UE SRSs:
receive, from the network entity, an indication to transmit the one or more inter-UE SRSs, and wherein, to transmit the one or more inter-UE SRSs, the at least one processor is configured to:
transmit, in response to the indication, the one or more inter-UE SRSs.

14. The apparatus of claim 12, wherein, to receive the communication configuration based on the one or more inter-UE SRSs, the at least one processor is configured to:
receive, from the network entity, the communication configuration based on the one or more inter-UE SRSs.

15. The apparatus of claim 12, wherein, to receive the communication configuration based on the one or more inter-UE SRSs, the at least one processor is configured to:
receive, from the second UE, the communication configuration based on the one or more inter-UE SRSs.

16. The apparatus of claim 13, wherein, to transmit the one or more inter-UE SRSs, the at least one processor is configured to:
beams sweep one or more inter-UE SRSs respectively over multiple transmit beams.

17. The apparatus of claim 16, wherein the communication configuration comprises a selected transmit beam of the multiple transmit beams.

18. The apparatus of claim 17, wherein the at least one processor is further configured to:
communicate physical uplink control channel (PUCCH) or physical downlink control channel (PDCCH) using the selected transmit beam.

19. The apparatus of claim 17, wherein the at least one processor is further configured to:
communicate with the second UE using the selected transmit beam.

20. An apparatus of wireless communication at a network entity, comprising: memory; and
at least one processor coupled to the memory and, based at least in part on information stored in the memory, the at least one processor is configured to:
transmit, to a first user equipment (UE), a first indication to transmit one or more inter-UE Sounding Reference Signals (SRSs);
receive, from a second UE, a communication configuration for inter-UE communication between the first UE and the second UE based on the one or more inter-UE SRSs; and
configure, based on the communication configuration, the first UE for communication with the second UE or the network entity.

21-30. (canceled)
